(19) United States
(12) Patent Application Publication
(10) Pub. No.: US 2004/0231801 A1
(43) Pub. Date: Nov. 25, 2004

(54) Door with variable length screen

(75) Inventors: Bruce E. Thomas, Brookings, SD (US); Kelly D. Nordgaard, Gary, SD (US); Bryan P. Zacher, Brookings, SD (US); Alan M. Dixon, Brookings, SD (US); Allen E. Lee, Brookings, SD (US)

Correspondence Address: Patterson, Thuente, Skaar & Christensen, P.A., 4800 IDS Center, 80 South 8th Street, Minneapolis, MN, 55402-2100, US

(73) Assignee: Larson Manufacturing Company

(21) Appl. No.: 10/880,319

(22) Filed: Jun. 29, 2004

Related U.S. Application Data
(63) Continuation of application No. 10/606,039, filed on Jun. 25, 2003.
Application No. 10/606,039 is a continuation of application No. 10/212,465, filed on Aug. 5, 2002, now Pat. No. 6,618,998.
(60) Provisional application No. 60/310,557, filed on Aug. 7, 2001.

(51) Int. Cl. E06B 9/08

(52) U.S. Cl. 160/27

(57) ABSTRACT

An exterior door incorporates at least one moving glass insert or sash slidable in first and second spaced apart tracks. An end of the insert is coupled to an end of a spring biased rolled screen. As the insert moves from the roll, the screen is extracted therefrom providing a continuously variable screened region in the door. The insert can be positioned using a counterbalance or spaced apart latchable locations in the door.

The present invention is a Continuation Application of U.S. application Ser. No. 10/606,039, filed Jun. 25, 2003, which claims priority to U.S. application Ser. No. 10/212,465, filed Aug. 5, 2002 and issued as U.S. Pat. No. 6,618,998, which in turn claims priority to U.S. Provisional Application No. 60/310,557, filed Aug. 7, 2001, wherein each of the referenced applications are incorporated herein by reference.

### FIELD OF THE INVENTION

The invention pertains to doors. More particularly, the invention pertains to doors having at least one slidable glass pane or panel with an extendable screen attached thereto.

### BACKGROUND OF THE INVENTION

Storm doors which incorporate panes of glass and screens are known. Some forms of such doors include screens which are fixedly mounted to the frame of the door with sliding glass inserts. With these doors, the inserts usually can be locked into a plurality of vertical positions with spring loaded latches to expose varying degrees of screen. When the inserts are moved to their fully close position, such as during storms or in cold weather, a person looking at the door, must look through at least one pane of glass and the screen.

In other forms of doors, glass inserts or screen inserts are installed on the doors' frame depending on the season. In warmer weather the glass insert is removed and a screen insert is used in the frame. In cooler weather, the screen is removed and a glass insert is attached to the frame. With such doors, an individual looking at the door looks through either a pane of glass or a screen but not both.

One known door configuration provides a fixed screen with a counterbalanced insert. In this configuration, the insert is not latched at a selected position on its track. The counterbalance makes it possible to position the insert at any desired position o the track. However, when the insert is in its closed position, a person viewing the door must look through both the glass insert and the screen.

Patio door configurations are known which include sliding glass doors which can be opened or closed to provide access to a patio or a porch. Spring biased screen modules are known which can be attached to the patio door frame. These modules include horizontally retractable screens which can be extended across a patio door opening to exclude insects or other flying pests.

While the known doors are generally suitable for their intended purpose, they all suffer from one or more deficiencies in performance, convenience and ease of use. There continues to be a need for multi-season doors which provide convenient and easy to use screened openings during warmer drier weather while at the same time making it possible to easily close the screened area with a glass pane during cooler or wetter weather. Preferably such doors could be manufactured, at least in part, using techniques for manufacturing existing doors so as to benefit from the economies of scale that such manufacturing capabilities provide. Additionally, it would be preferable if such doors were easy to maintain and designed to be forgiving in the event that the screen is in need of replacement.

Numerous other advantages and features of the present invention will become readily apparent from the following detailed description of the invention and the embodiments thereof, from the claims and from the accompanying drawings.

### BRIEF DESCRIPTION OF THE DRAWINGS

FIG. 1A is a front elevational view of a door in accordance with the present invention;

FIG. 1B is a top plan view of the door of FIG. 1A;

FIG. 1C is a side view of the door of FIG. 1A;

FIG. 2A is a rear elevational view of the door of FIG. 1A;

FIG. 2B is a rear elevational view of an alternate door in accordance with the invention;

FIG. 3A is an exploded view of the door of FIG. 1A;

FIG. 3B is a rear isometric view of the door of FIG. 1A;

FIG. 4A is an exploded view of an alternate embodiment of the door of FIG. 1A;

FIG. 4B is a rear isometric view of the door of FIG. 4A;

FIGS. 5A and B are side sectional views taken along plane 5A-5A of the door of FIG. 1A;

FIG. 5C is a sectional view taken along plane 5C-5C of the door of FIG. 1A;

FIG. 5D is an enlargement of a portion of the section of FIG. 5C;

FIG. 5E is a sectional view taken along plane 5E-5E of FIG. 5A;

FIG. 5F is an enlarged partial view of a portion of the door of FIG. 1A illustrating details thereof;

FIG. 5G is an enlarged partial view illustrating details of an alternate embodiment of the door of FIG. 1A;

FIGS. 6A, 6B and 6C taken together are isometric views illustrating a process of engaging an extendable screen cloth with the jambs of the door of FIG. 1A;

FIGS. 7A-7C illustrate details of a replaceable screen module usable in the door of FIG. 1A;

FIG. 8 is a rear isometric view of the door of FIG. 1A illustrating aspects of removing and replacing the screen module;

FIG. 9 is an enlarged region of a portion of FIG. 8 illustrating additional details thereof;

FIG. 10 is a front elevational view of another door which embodies the invention;

FIG. 10A is a side section of the door of FIG. 10 taken along plane 10A-10A;

FIG. 11 illustrates an end sectional view of a plurality of alternate mechanisms for coupling a retractable screen to a movable door insert; and

FIG. 12 is a rear elevational view of another door in accordance with the present invention.

### DETAILED DESCRIPTION OF THE PREFERRED EMBODIMENTS

While this invention is susceptible of embodiment in many different forms, there are shown in the drawing and will be described herein in detail specific embodiments thereof with the understanding that the present disclosure is to be considered as an exemplification of the principles of the invention and is not intended to limit the invention to the specific embodiments illustrated.

In one embodiment of the invention, an exterior door incorporates a replaceable screen module which includes an integral, spring biased, retractable screen which is coupled to a movable glass insert in the door. As the insert is moved from the screen, the screen is withdrawn from its retracted position and extends along the frame of the door screening the otherwise open region from which the glass insert has moved. As the window sash or insert moves in the opposite direction toward the screen module, the screen is retracted into the module reducing the ventilation region available in the door.

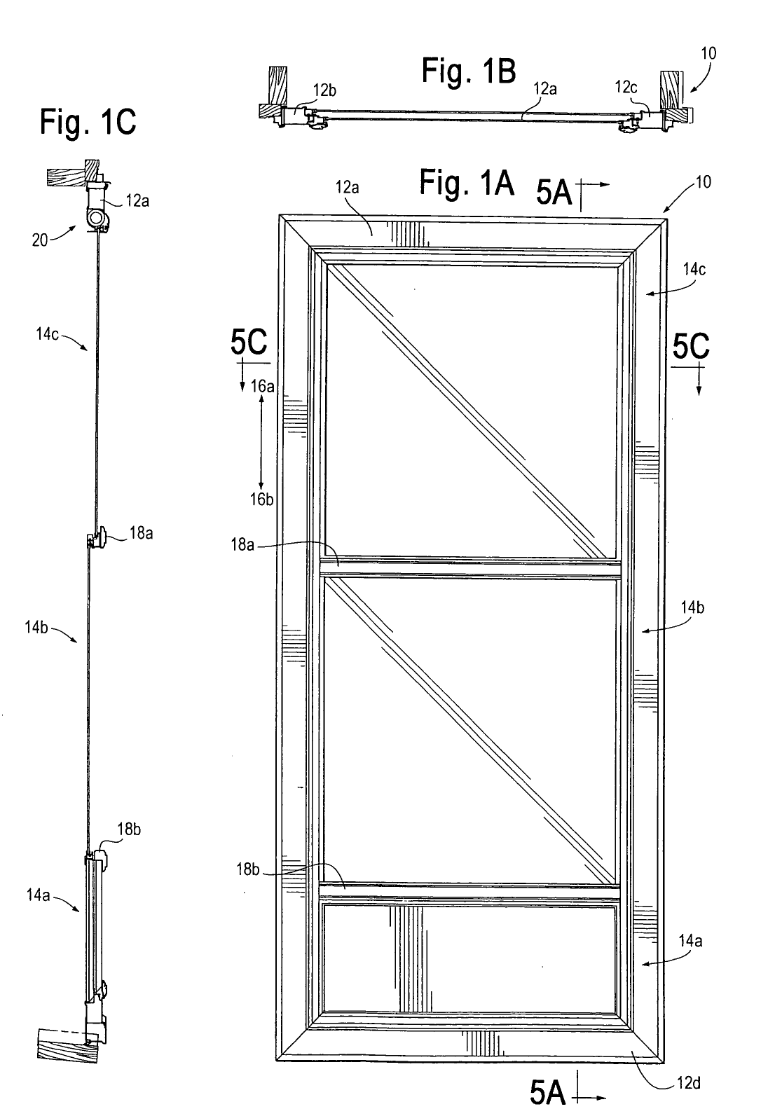

FIGS. 1A-1C illustrate various views of a door 10 which embodies the present invention. The door 10 includes a header 12a, two door jambs 12b, c and a sill 12d. The members 12a . . . d define a door frame with an interior region which in the door 10 includes a kick plate generally indicated at 14a, a lower pane or glass insert 14b, and an upper pane or glass insert 14c. Mullions 18a, b on the exterior side of the frame join jambs 12b, c.

In the door 10, the pane or insert 14b is fixedly mounted between the jambs 12b, c and above the kick plate 14a. The pane or insert 14c is mounted in tracks, discussed in more detail subsequently, for vertical motion generally in directions 16a, b relatively to insert 14b.

When the insert 14c is positioned at its uppermost location adjacent to header 12a, the door 10 is fully closed with two glass panes as one would use it in cool or wet weather. The pane or insert 14c can be moved, vertically, in direction 16b, away from header 12a thereby opening the upper portion of door 10 for ventilation.

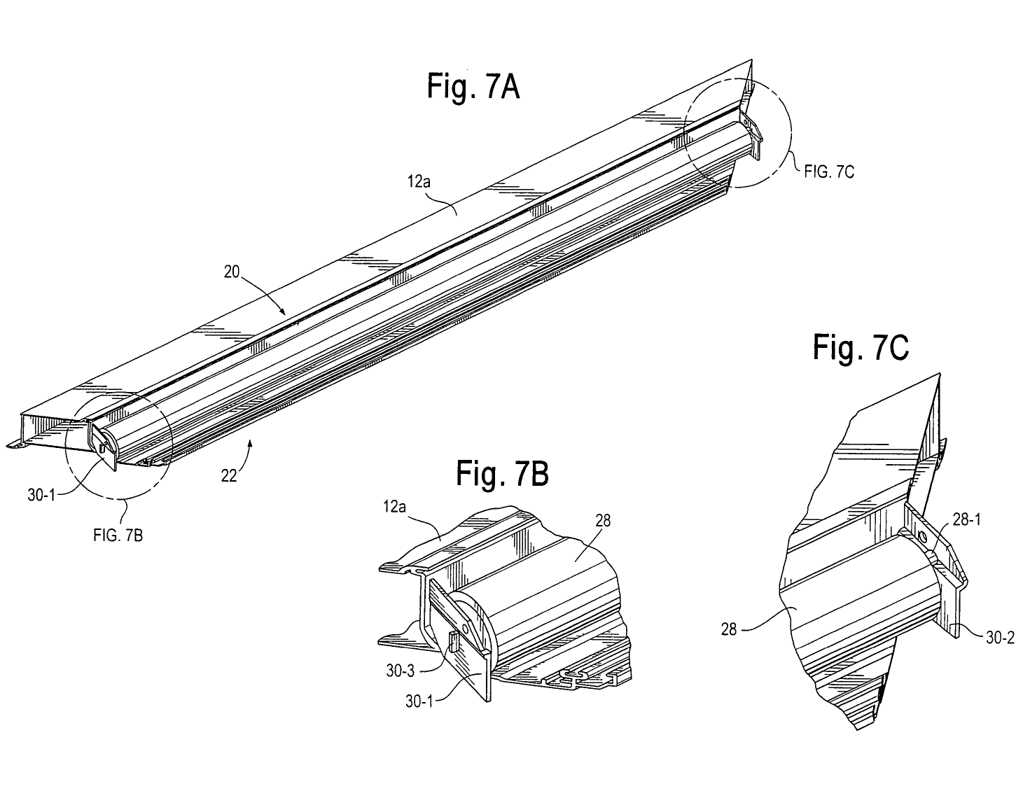

A screen module 20, best seen in FIG. 7A can be coupled to the jambs 12b, c, header 12a or sill 12d. Module 20 carries a retracted screen which has a free end which carries an attachment member 22 which is coupled to an upper end of insert 14c. As the insert 14c is moved in the direction 16b, screen fabric or material 22-1 from the module 20 is extracted therefrom filling any gap or space between an upper end of insert 14c and header 12a.

Door 10 can thus, as described above, be converted from a storm door with two glass panes to a screen door simply by moving pane or insert 14c vertically downwardly. Where insert 14c is moved vertically downwardly to kick plate 14a, the extracted screen fills the entire area previously closed by pane 14c.

When the insert 14c is raised, direction 16a, the screen material 22-1 retracts into module 20 for storage. As discussed below, module 20 is removable for maintenance or replacement.

It will be understood that alternate configurations to the door 10 come within the spirit and scope of the present invention. For example, the screen module 20 can be mounted at or near the base 12d to provide an openable lower screened region. Alternately, instead of screening material, sheet plastic could be used in the module 20.

Members 12a-12d of the frame for the door 10 can be formed of metal, such as extruded aluminum, extruded or molded plastic, or partly or completely of a wood product. Inserts 14b, c need not include glass but could in fact be closed with translucent or transparent plastic material without departing from the spirit and scope of the present invention.

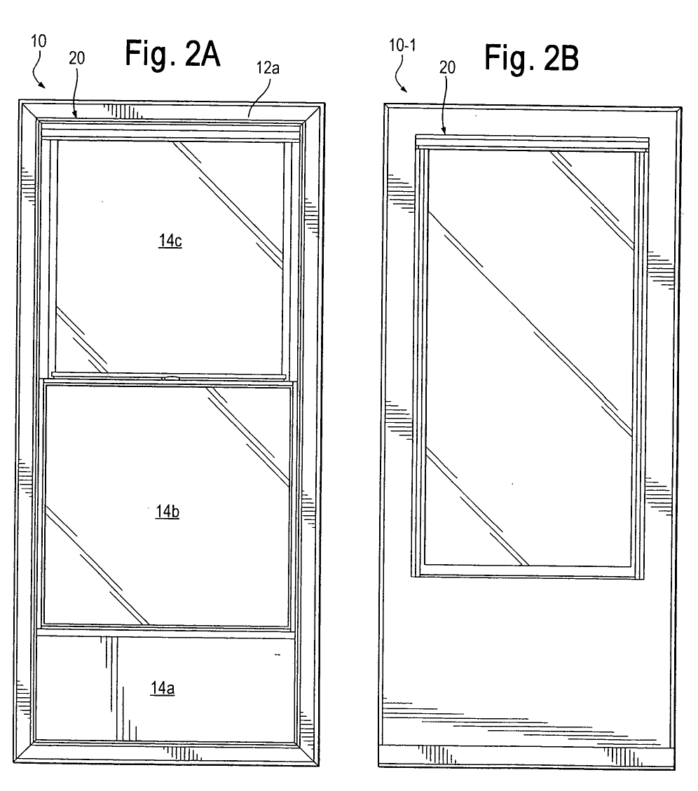

FIG. 2A is a rear elevational view of the door 10 illustrating the location of screen module 20 adjacent to header 12a. Screen module 20 is enclosed by a removable cover 24 which can be removed for purposes of maintenance and for replacing the module 20.

FIG. 2B illustrates an alternate embodiment, a wood core door 10-1 which incorporates screen module 20. The wood core door 10-1 can be formed with a wood-products core covered with either metal, such as aluminum, or cured resin such as vinyl. It will be understood that the screen module 20 is coupled to a sash or insert, comparable to the insert 14c, which moves vertically in tracks, as would be understood by those of skill, in the frame for the door 10-1.

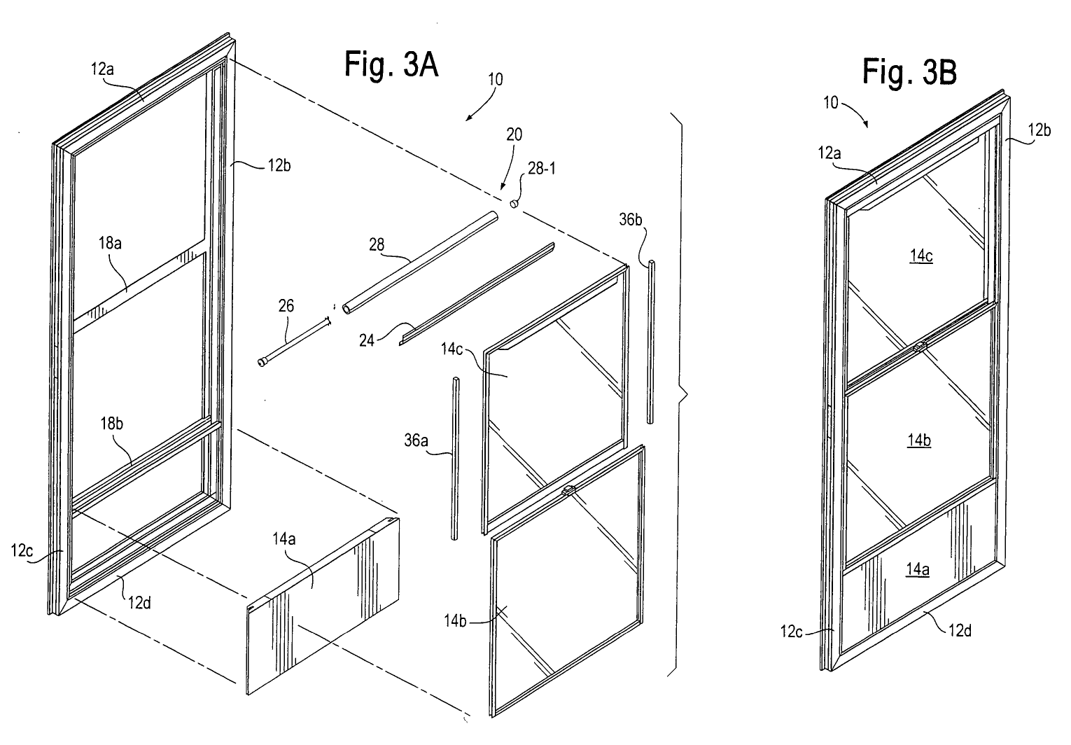

FIGS. 3A and 3B are an exploded view of the door 10 and a rear isometric view thereof.

As illustrated in FIG. 3A, module 20 incorporates a spring or retractor assembly 26 which is carried in a hollow screen roll or cylinder 28. The cylinder 28 rotates about retractor assembly 26 and pivot cap 28-1.

The module 20 is attached to the door so as to permit rotary motion thereof by brackets 30-1 and 30-2, best seen in FIGS. 7A-C. Screen roll 28 carries the coiled screen fabric 22-1 with attached connection member 22, best seen in FIG. 7B.

The spring assembly 26 exerts a substantially constant retracting force on the spring fabric on the roll 28 as the insert 14c is moved vertically in directions 16a, b. The screen material 22-1 is thus constantly under tension.

The insert 14c in door 10, is counterbalanced by counterbalancing mechanisms 36a, b carried by the insert 12a. The counterbalancing mechanisms 36a, b move with the insert 14a in the jambs 12b, c and are invisible to the user. Types of counterbalances include block and tackle balance, spiral balance and coil spring balance.

The counterbalances 36a, b make it possible to smoothly move the insert 14c in the direction 16a, b. The insert 14c can be positioned anywhere along its range of travel and will remain there until moved due to the forces exerted by the counterbalance mechanisms 36a, b.

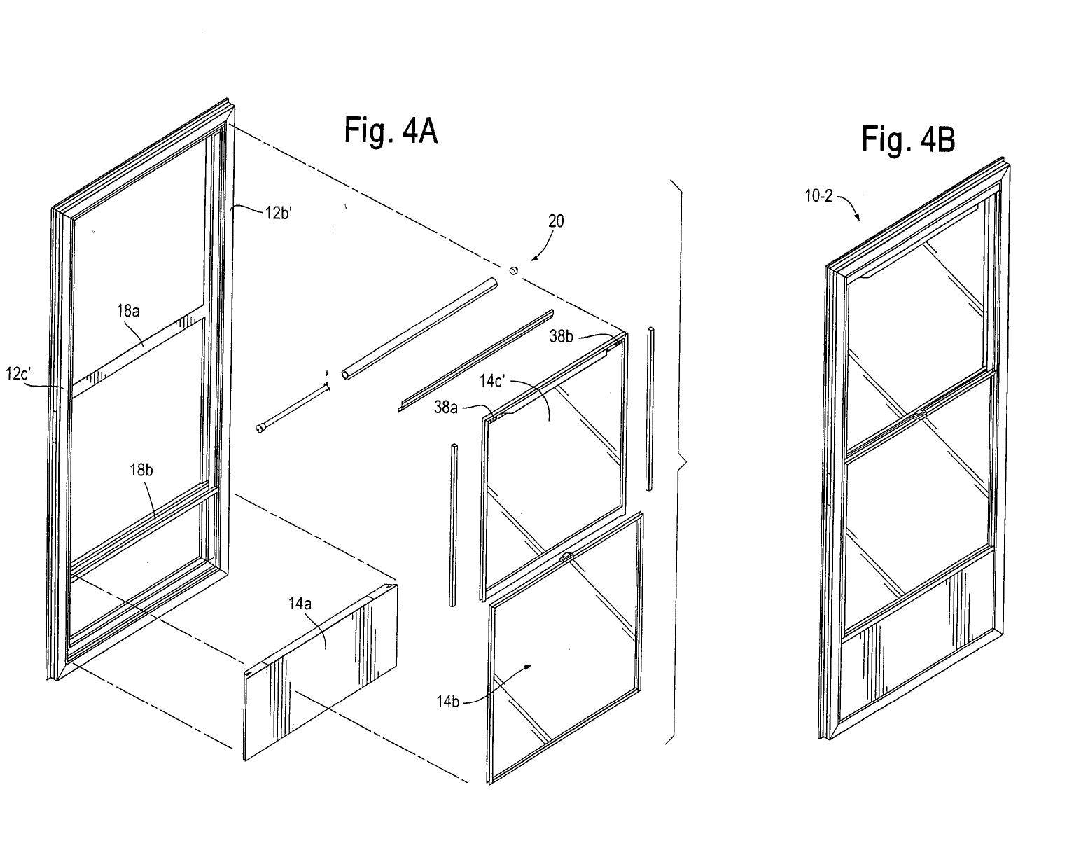

FIGS. 4A, B illustrate an alternate embodiment, a door 10-2, which embodies the present invention. Those elements of door 10-2 which correspond to previously discussed elements of the door 10 have been assigned the same identification numerals. As an alternate to the counterbalance mechanisms 36a, b, the door 10-2 incorporates spring biased finger operable latches 38a, b which are carried by the insert 14c′. The latches extend laterally outwardly into slots in the jambs 12b′, c′ to lock the insert 14c′ into a plurality of spaced apart vertical positions.

In the door 10-2, the insert 14c′ can be moved vertically to a locking position, the movement will retract the screen 22-1 off of the roll 28 and filling the area of the door frame from which the insert 14c′ has been moved. The mechanical latches 38a, b will lock the insert 14c′ at the desired degree of openness in the frame of the door 10-2 desired.

In yet another embodiment, insert 14c can frictionally engage tracks in jambs 23b, c. The frictional forces will support insert 14c at any one of a variety of positions. In this embodiment, no counterbalances or latches are needed.

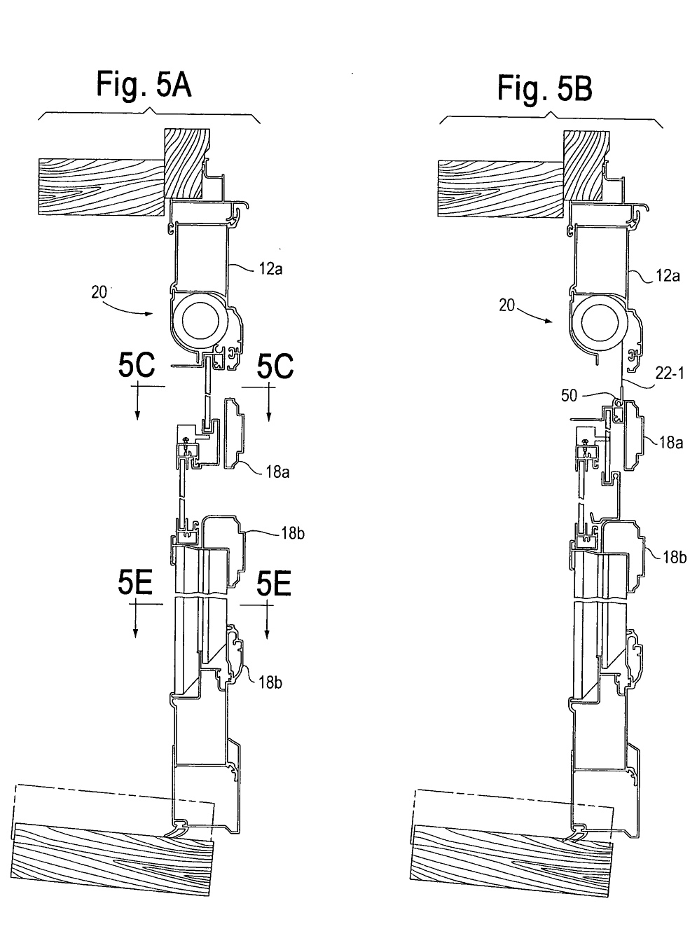

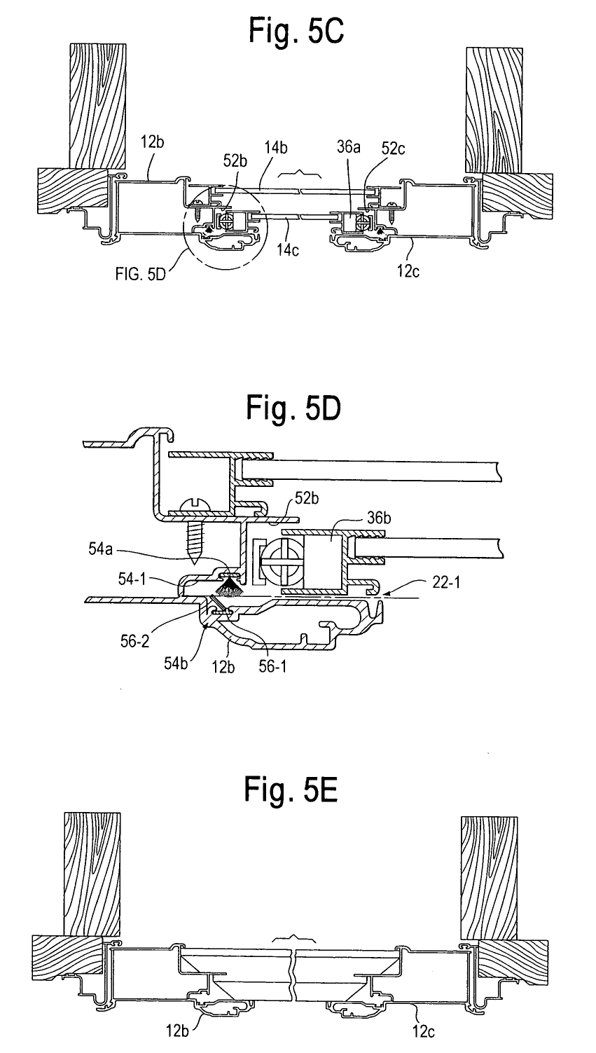

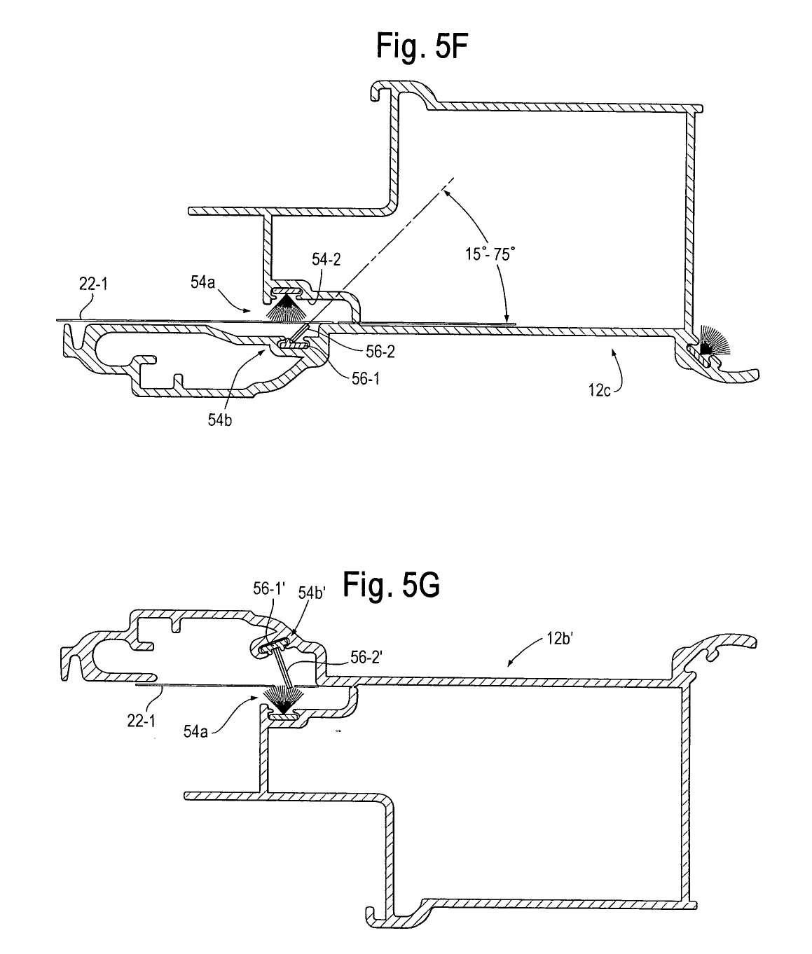

FIGS. 5A and 5B are sectional views taken along plane 5A-5A of FIG. 1A. The views of FIGS. 5A, B illustrate the relationship of various structural elements of the door 10 as the insert 14c moves from a fully closed position, FIG. 5A, to a partially open position, FIG. 5B. FIG. 5B illustrates the extended screen fabric 22-1.

FIG. 5C, a section taken along plane 5C-5C of FIG. 1A illustrates the insert tracks 52b, 52c which run axially along each of the jambs 12b, c. The insert 14c moves axially in and is retained within those tracks.

As illustrated in FIG. 5B, the insert 14c which is coupled to the screen fabric 22-1 moves axially in tracks 52b, c between insert 14b and mullion 18a. The screen end retaining member 22 is slidably received in a retaining feature 50 located at an upper end of the insert 14c.

Edges of the screen fabric 22-1 are confined in axial tracks 54-1, -2. These can be formed in jambs 12b, c.

FIG. 5D illustrates the counterbalance mechanism 36a, b which is carried by the insert 14c. Hence, insert 14c can be located at any vertical position on its range of travel as defined by the tracks 52b, 52c along the jambs 12b, c. When so positioned, the screen fabric 22-1, will be extended from the module 20 to the connector feature 50 to close the opening in the frame of the door 10 left by moving the insert 14c to a position closer to the kick plate 14a.

FIG. 5D also illustrates the screen material 22-1, illustrated in phantom, extended, as in FIG. 5B, extending between first and second weather stripping elements 54a and 54b. Weather stripping element 54a extends axially along the respective jamb 12b, c on each side of the door 10. The weather stripping 54a can be any form of weather stripping as would be known to those of skill in the art.

The weather stripping 54b is different and unlike the weather stripping 54a. The weather stripping 54b is also positioned in an axially oriented slot which runs along the jambs 12b, c.

Weather stripping 54b is commercially available from Reddiplex Group PLC, Worchestershire, England under the trade name “MESHLOCK” and is formed with a mounting section 56-1 which slidably engages the respective slot in the jamb 12b, c. The mounting section 56-1 carries a deflectable planar element 56-2 which extends from the mounting section 56-1 toward the weather stripping 54a at a predetermined angle in a range of 15-75° relative to the plane of the screen.

The weather stripping 54a acts to press the edge of the screen material 22-1 toward the MESHLOCK-type weather stripping 54b, see FIG. 5F. This interaction provides a screen edge retention function. The fibers of the MESHLOCK weather stripping 54b resist screen material 22-1 being pulled from between weather stripping 54a, b, and the tracks 54-1, -2.

It will be understood that other commercially available forms of weather stripping can be used instead of the MESHLOCK brand without departing from the spirit and scope of the invention.

It will be understood that while the MESHLOCK weather strip 54b has been illustrated in FIGS. 5D and 5F as exhibiting an acute angle between the mounting section 56-1 and the screen retaining section 56-2, other variations of MESHLOCK weather stripping could be used. Alternately as in FIG. 5C, the members 56-1′, -2′ could be oriented at 90° to one another. In this embodiment, the track in which the mounting section 56-1′ would be located would be oriented at an appropriate angle, best seen in FIG. 5G, relative to the respective jamb 12b, c to provide the desired interaction of pressing the screen material 22-1 between the weather stripping 54a, 54b′.

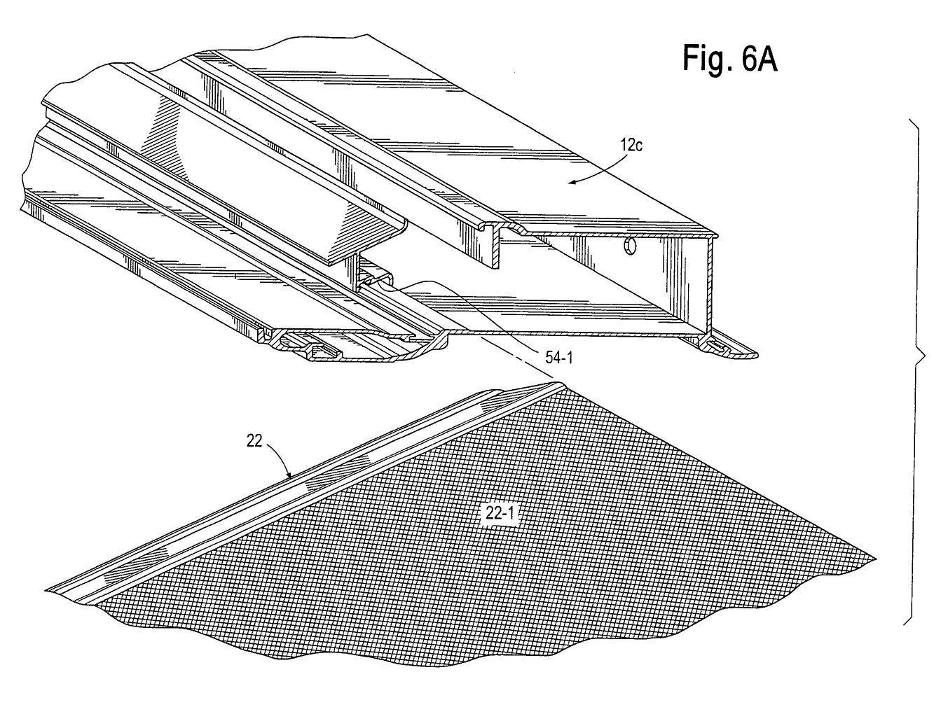

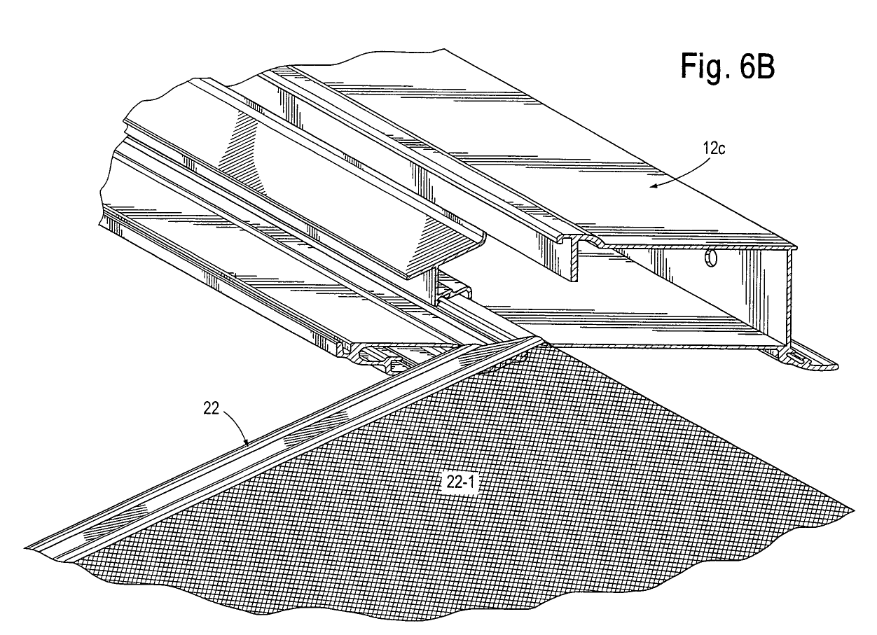

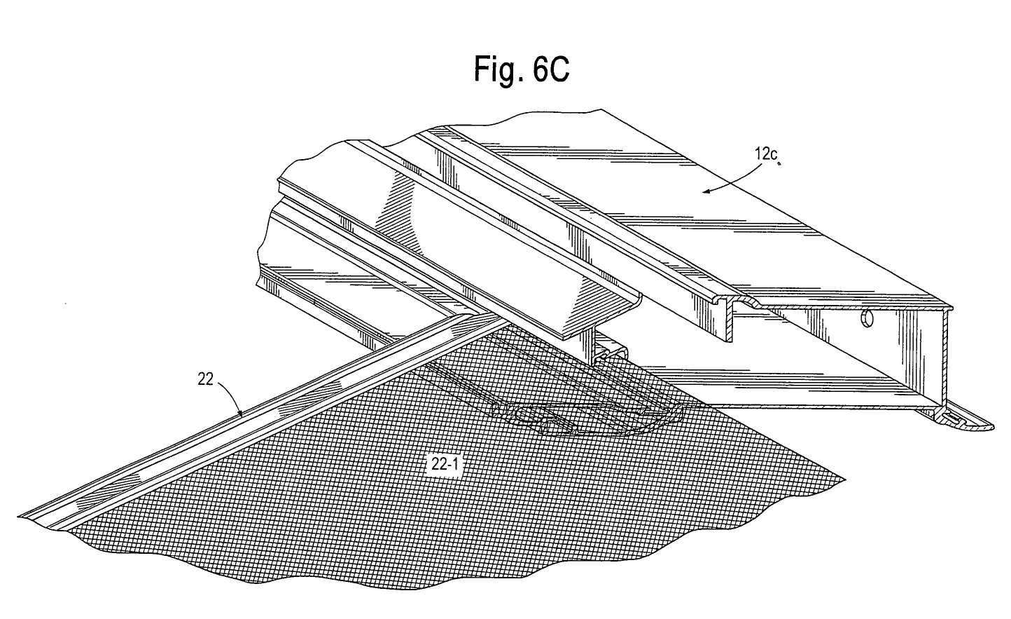

FIGS. 6A, B and C taken together illustrate screen fabric or cloth 22-1 slidably engaging track 54-1, similarly 54-2, located in each of the jambs 12b, c and which extend axially along the jamb. The end attachment feature 22 also slidably engages the track or slot 54-1, -2 on each of the jambs 12b, c.

Though the screen cloth or material 22-1 may be forced out of the respective tracks 54-1, -2 in each of jambs by a laterally directed force, the screen attachment member 22 will continue to remain in each of the tracks. This is facilitated by the shape of the attachment member 22 which includes an end region 23 which extends into the respective slot 54-1, -2.

In this instance, assuming that the screen cloth 22-1 has been forced from the respective track 54-1, the upper insert 14c can be moved to its fully closed position adjacent to header 12a to retract the screen onto the screen roll 28. In this circumstance, the attachment feature 22 is properly aligned to re-enter the tracks 54-1. As the insert 14c is moved away from the header 12a, it will pull the attachment member 22 with it. The ends 23 of the attachment member 22 will enter the respective slots 54-1 pulling the screen cloth 22-1 with them and retracking the screen. Alternately, the attachment member 22 can exhibit a retracted condition, adjacent to the screen module 20 while continuing to remain in the tracks 54-1.

Thus, as described above, if a force is exerted against the screen material 22-1 to pull it out of the side tracks 54-1 in each jamb, it is only necessary to reclose the insert 14c to rewind the screen material 22-1 into a proper configuration so that it will be immediately re-extendable into the slots or tracks 54-1.

FIGS. 7A, 7B and 7C illustrate additional details of the screen module 20. The module 20 is supported adjacent to the header 12a by brackets 30-1, -2. Module 20 can be removably attached to the header, the sill or the jambs. The module 20 is removable from the brackets 30-1, -2 for maintenance and/or replacement once the cover 24 has been removed from the respective door.

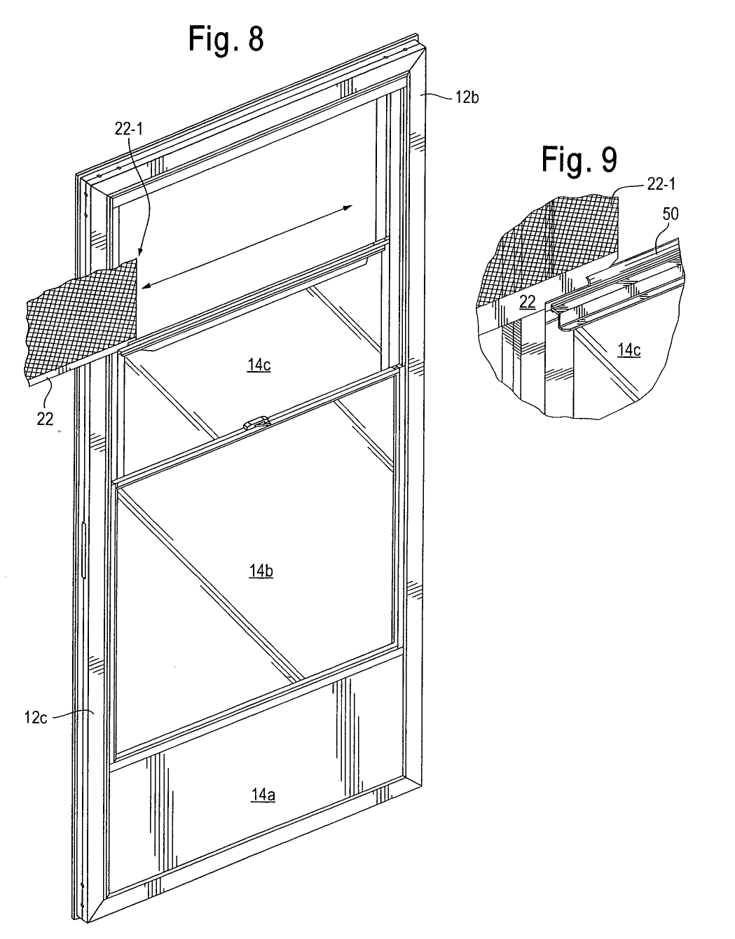

FIG. 8 illustrates additional details of removing and replacing the module 20. The connecting member 22 can be slid from the retaining feature 50 of the insert 14c as illustrated in FIGS. 8 and 9. When so-slid from the retaining feature 50, the entire module 20 can be replaced. Replacement involves attaching the connecting member of the new module to the attachment feature 50 by reversing the process illustrated in FIGS. 8 and 9. The screen roll 28 and screen fabric 22-1 can then be reattached brackets such as brackets 30-1, -2 in the header of the respective door. The cover 24 can be replaced. Moving the insert 14c vertically toward and away from the header will cause the screen fabric 22-1 of the replacement module to retract and extend as expected.

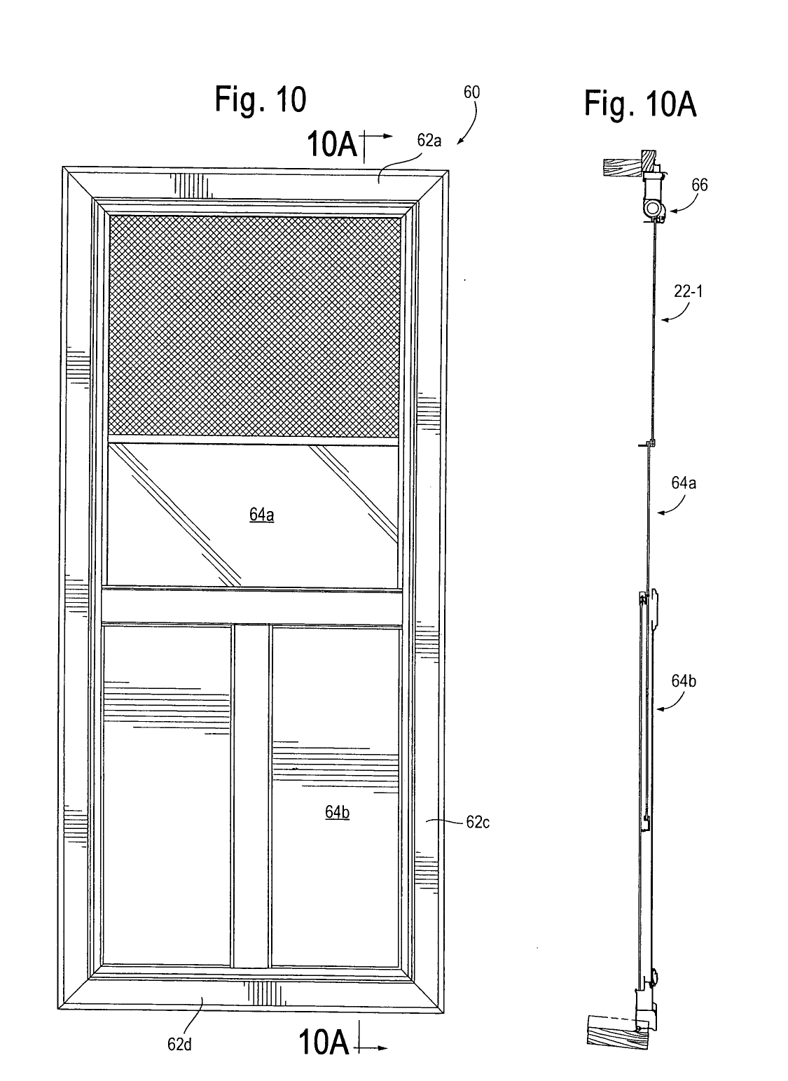

FIGS. 10, 10A and 10B illustrate a door 60 which has a header 62a, jambs 62b, c and a sill 62d. The door 60 includes insert 64a which is movable vertically toward the header 62a and away therefrom toward the sill 62d. The insert 64a can be supported by counterbalances, latches or frictional forces as discussed above relative to the door 10.

The door 60 carries a screen module 66, best illustrated in FIG. 10A. A free end of the screen of the screen module 66 is coupled to an upper end of insert 64a as discussed above.

A lower panel 64b of the door 60 is hollow and contains a space into which the insert 64a can be stored as it is moved downwardly toward the sill 62d. In this configuration, where the insert 64a is partly open, a portion of the screen 66a extends from the screen module 66 and fills the open space between jambs 62b,c and header 62a. The remainder of the space between the jambs 62b, c is filled by a portion of the insert 64a and the panel 64b. Thus, the door 60 provides convenient out of sight storage for the insert 64a.

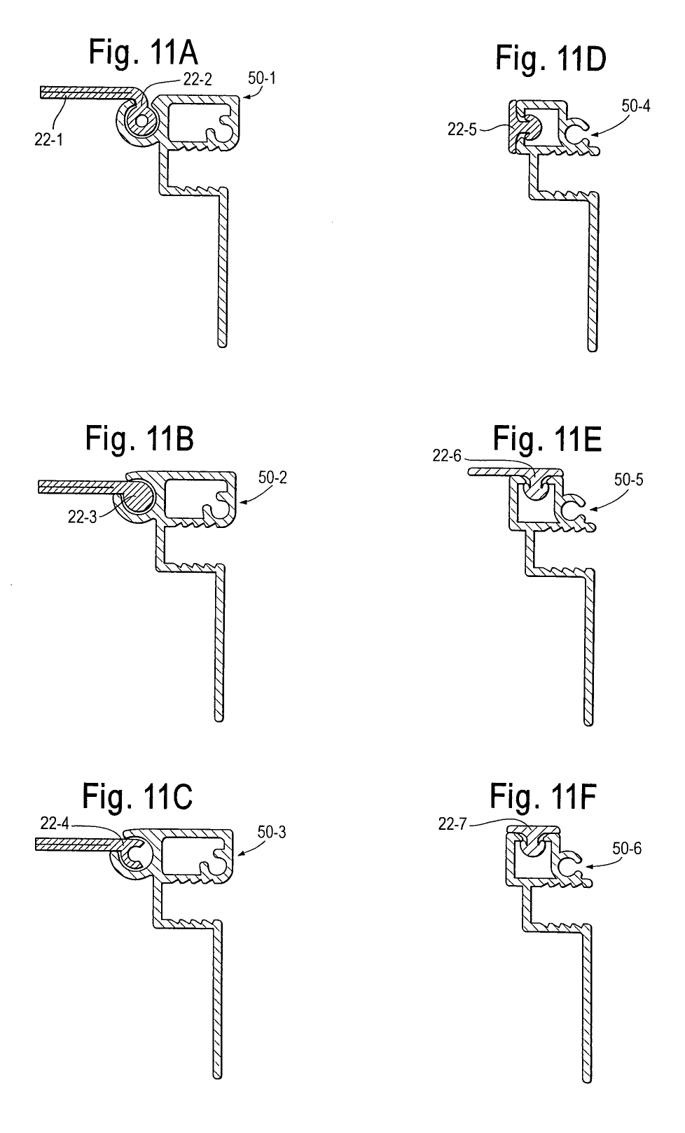

FIG. 11 illustrates a plurality of alternate coupling members 50-1 . . . 50-6 that could be carried on the movable insert or pane, such as the insert 14c, and couplable to a free end of the screen fabric 22-1. As illustrated in FIG. 11, in each instance, the free end of the screen 22-1 would include a coupling element, such as 22-2 . . . 22-7 which would slidably engage the respective coupling member 50-1 . . . 50-6.

It will be understood that other arrangements can be used to attach a free end of the screen member 22-1 to a moving insert or pane. Alternates or include a spline which would trap the free end of the screen fabric 22-1 in contact with the movable inserts such as 14c clamps or adhesives. Other variations come within the spirit and scope of the invention.

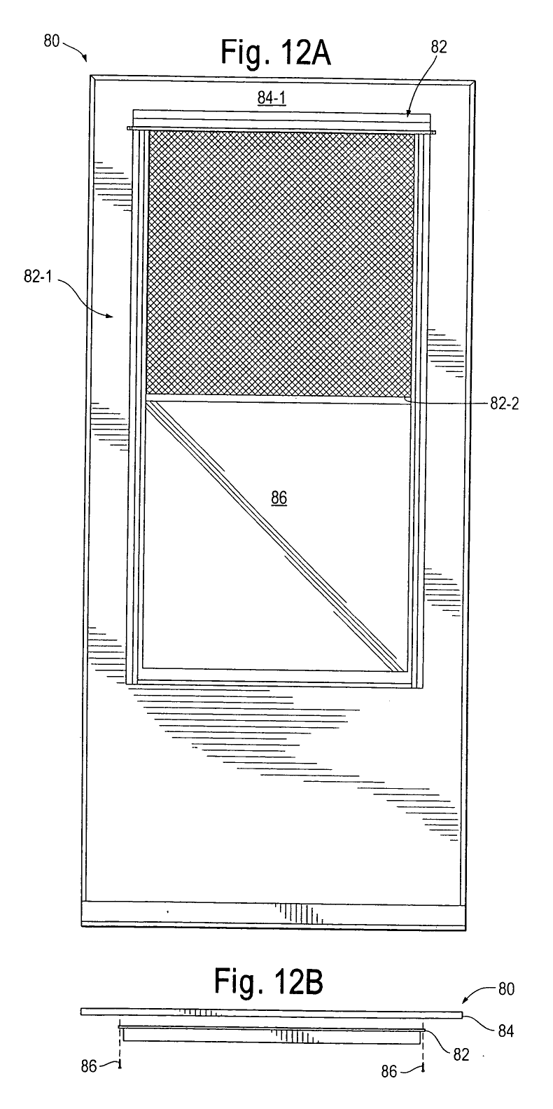

FIG. 12 illustrates a door 80 which incorporates a screen module 82, of the type discussed previously, which can be attached to door 84 as an after the fact accessory or add-on. The module screen 82 can be attached to the door 84 by fasteners 86 in the vicinity of the header 84-1 of the door.

The screen fabric 82-1 can be pulled from the module 82 to close an opening in the door created by moving insert 86 downwardly away from the module 82. A free end 82-2 of the screen material 82-1 is attached to the sash or insert 86. Attachment can be effected by any of the previously discussed methods including using a spline, adhesive, providing attachment clips which slidably engage a portion of the sash of the insert 86. Other attachment vehicles can be used to connect the free end 82-2 to an upper end of the insert or sash 86 without departing from the spirit and scope of the present invention.

As the sash or insert 86 is moved toward the screen module 82, the fabric 82-1 rollably retracts into the module 82 as a result of the internal spring mechanism, discussed above, in connection with door 10. The screen material 82-1, also as discussed above, is under a constant pulling force due to the spring biasing mechanism of the module 82 which continually attempts to retract the fabric 82-1 into the module 82. Thus, as the sash or insert 86 moves toward the module 82, the screen material 82-1 is immediately rolled into the module 82 for out of the way storage.

It will also be understood that a resin or plastic sheet could be used as an alternate to screen fabric 82-1 without departing from the spirit and scope of the present invention. Thus, the screen module 82 provides a mechanism for adding to any existing door, after installation, a retractable screen feature such that existing screen panels or inserts in the door can be removed. This improves convenience and visibility in that with the sash or insert 86 closed, the screen fabric 82-1 is completely retracted and an individual looking at the door looks directly through the glass inserts or sashes without having to look through a screen.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

What is claimed:

1. A storm door comprising:
a frame including
first and second spaced apart jambs;
a header portion and an opposing base portion, the header portion and the base portion disposed generally transverse to the first and second spaced apart jams; and
at least one track axially provided along a portion of each of the first and second spaced apart jambs and including an elongate sealing portion provided thereto;
a sash including
first and second end portions; and
first and second side portions, wherein at least one of the first and second side portions is displaceable within the at least one axially oriented track of the first and second jambs;
a spring biased roller;
a screen material having first and second end portions and first and second side portions, wherein the first end portion is securable to the spring biased roller to enable wrapping of the screen material onto the roller and deployment of the screen material from the roller, and the second end portion is securable to the first end portion of the sash; and
whereby the screen material is deployable under tension from the spring biased roller during displacement of the sash within the at least one track of the first and second spaced apart jambs to define a generally planar extended screen portion substantially maintained by the biasing tension of the roller such that at least one of the side portions of the screen material abuttably engages the elongate sealing portion.

2. The storm door of claim 1, wherein the elongate sealing portion includes a length of weather stripping.

3. The storm door of claim 1, further including a second elongate sealing portion such that the second elongate sealing portion substantially confronts the other elongate sealing portion.

4. The storm door of claim 3, wherein the elongate sealing portion and the second elongate sealing portion include a length of weather stripping.

5. The storm door of claim 1, wherein substantially all of the screen material is wrapped around the spring biased roller to define a wrapped diameter for the spring biased roller at least as large as the thickness of the header.

6. The storm door of claim 5, wherein the wrapped diameter for the spring biased roller is offset longitudinally from the header such that a portion of the wrapped diameter extends out from the header.

7. The storm door of claim 1, further including a counterbalance system operably coupled to the sash to provide a counteracting force with that of the tension of the spring biased roller.

8. The storm door of claim 1, wherein the sash includes at least one latch mechanism to selectively limit displacement of the sash.

9. The storm door of claim 1, wherein the at least one track includes two adjacent tracks such that one of the two tracks is adapted to slidably receive the sash and the other of the two tracks is adapted to slidably receive one of the first and second side portions of the screen material.

10. A storm door comprising:
a frame including
first and second spaced apart jambs, each carrying at least one axially oriented track; and
a header portion and an opposing base portion, the header portion and the base portion disposed generally transverse to the first and second spaced apart jams;
a spring biased roller adapted to rollably receive and deploy a screen material;
the screen material having first and second ends and first and second edges, and attachable to the spring biased roller at the first end such that when the screen material is substantially rolled onto the spring biased roller a wrapped diameter for the spring biased roller is defined that is generally equal to or larger than the thickness of a thinnest portion of the header;
a sash with first and second ends and first and second edges, the first and second edges of the sash being displaceable within the at least one axially oriented track of the spaced apart jambs, and the first end of the sash adapted to securely accept the second end of the screen material;
whereby, when the second end of the screen material is attached to the first end of the sash and the first end of the screen material is attached to the spring biased roller, and the first and second edges of the sash are displaced within the at least one axially oriented track of the spaced apart jambs, the spring biased roller correspondingly displaces the screen material such that the screen material moves with the sash under a retracting tension from the spring biased roller; and
whereby the retracting tension maintains any deployed portion of the screen material in a generally planar shape and maintains the first and second edges of the screen material generally confrontingly secure within the at least one axially oriented track of the space apart jambs.

11. The storm door of claim 10, wherein the at least one axially oriented track includes at least one elongate sealing portion.

12. The storm door of claim 11, wherein the screen material is generally confrontingly secured within the axially oriented track by abuttably engaging the at least one elongate sealing portion.

13. The storm door of claim 11, wherein the at least one elongate sealing portion includes a length of weather stripping.

14. The storm door of claim 10, wherein the wrapped diameter for the spring biased roller is offset longitudinally from the header such that a portion of the wrapped diameter extends out from the header.

15. The storm door of claim 10, further including a counterbalance system operably coupled to the sash to provide a counteracting force with that of the tension of the spring biased roller.

16. The storm door of claim 10, wherein the sash includes at least one latch mechanism to selectively limit displacement of the sash.

17. The storm door of claim 10, wherein the at least one track includes two adjacent tracks such that one of the two tracks is adapted to slidably receive the sash and the other of the two tracks is adapted to slidably receive one of the first and second side portions of the screen material.

18. The storm door of claim 10, wherein the spring biased roller is housed within a module proximate the header such that the spring biased roller is selectively removable from the module.

19. A storm door comprising:
a frame including
first and second spaced apart jambs;
a header portion including a front face and a back face to define a header thickness and a longitudinal center therethrough;
a base portion opposing the header portion, wherein the header portion and the base portion are disposed generally transverse to the first and second spaced apart jams; and
at least one track axially provided along a portion of each of the first and second spaced apart jambs and having at least one elongate sealing portion attached thereto;
a sash including
first and second end portions; and
first and second side portions, wherein at least one of the first and second side portions is displaceable within the at least one axially oriented track of the spaced apart jambs;
a spring biased roller provided generally parallel to the header and having a roller longitudinal axis offset from the longitudinal center of the header;
a screen material having first and second end portions and first and second side portions, wherein the first end portion is securable to the spring biased roller to enable wrapping of the screen material onto the roller and deployment of the screen material from the roller, the wrapping of substantially all of the screen material onto the roller defining a wrapped diameter for the roller that extends out from one of the front or back faces of the header; and
whereby the screen material is deployable under tension from the spring biased roller during displacement of the sash within the at least one track of the spaced apart jambs to define a generally planar extended screen portion substantially maintained by the biasing tension of the roller such that at least one of the side portions of the screen material abuttably engages the at least one elongate sealing portion.

20. The storm door of claim 19, wherein the at least one elongate sealing portion includes a length of weather stripping.

21. The storm door of claim 19, further including a counterbalance system operably coupled to the sash to provide a counteracting force with that of the tension of the spring biased roller.

22. The storm door of claim 19, wherein the sash includes at least one latch mechanism to selectively limit displacement of the sash.

23. The storm door of claim 19, wherein the at least one track includes two adjacent tracks such that one of the two tracks is adapted to slidably receive the sash and the other of the two tracks is adapted to slidably receive one of the first and second side portions of the screen material.

24. The storm door of claim 19, wherein the spring biased roller is housed within a module proximate the header such that the spring biased roller is selectively removable from the module.

25. A storm door comprising:
a frame including
first and second spaced apart jambs;
a header portion including a front face and a back face to define a header thickness and a longitudinal center axis therethrough;
a base portion opposing the header portion, wherein the header portion and the base portion are disposed generally transverse to the first and second spaced apart jams; and
at least one track axially provided along a portion of each of the first and second spaced apart jambs and having at least one elongate sealing portion attached thereto;
a sash insert including
first and second end portions; and
first and second side portions, wherein at least one of the first and second side portions is displaceable within the at least one axially oriented track of the spaced apart jambs;
a spring biased roller provided generally parallel to the header and having a roller longitudinal axis offset from the longitudinal center axis of the header;
a screen material having first and second end portions and first and second side portions, wherein the first end portion is securable to the spring biased roller to enable wrapping of the screen material onto the roller and deployment of the screen material from the roller, and the second end portion of the screen material is securable to the first end portion of the sash insert, whereby the screen material is wrappable around the spring biased roller to define a wrapped diameter for the spring biased roller at least equal to the thickness of the header; and
whereby the screen material is deployable under tension from the spring biased roller during displacement of the sash insert within the at least one track of the spaced apart jambs to define a generally planar extended screen portion substantially maintained by the biasing tension of the roller such that at least one of the side portions of the screen material abuttably engages the at least one elongate sealing portion.

26. The storm door of claim 25, wherein the at least one elongate sealing portion includes a length of weather stripping.

27. A method of operation of a storm door having a variable length screen, comprising the steps of:
providing a storm door including a frame having spaced apart jambs, a header portion, and an opposing base portion; at least one track axially provided along a portion of each of the spaced apart jambs and including an elongate sealing portion provided thereto; a sash insert having first and second insert end portions and side portions such that at least one of the side portions is displaceable within the at least one axially oriented track; a spring biased roller adapted to rollably receive and deploy a screen material having first and second screen end portions and first and second screen side portions, wherein the second screen end portion is securable to the first insert end portion of the sash insert;
displacing the sash insert within the at least one track, wherein the screen material is wrapped onto the spring biased roller during a first directional movement of the sash insert and is deployable from the spring biased roller during an opposite second directional movement of the sash insert; and
abuttable engaging of at least one of the screen side portions within the at least one track such that the at least one of the screen side portions is substantially maintained within the at least one track by the biasing tension of the roller.

28. The method of claim 27, further comprising providing at least one elongate sealing portion attached to the at least one track for the abuttable engaging of the at least one of the screen side portions within the at least one track.

29. The method of claim 28, wherein the step of providing the at least one elongate sealing portion includes providing a length of weather stripping.

30. A storm door comprising:
first and second spaced apart jambs, a header, and a base defining a storm door frame, the storm door frame defining an inner region and presenting a storm door frame width defined between a storm door frame first surface and a storm door frame second surface, at least a portion of the storm door frame being hingedly pivotable proximate one of the spaced apart jambs;
at least one track axially provided along a portion of each of the first and second spaced apart jambs and having at least one face surface defining a track abutment plane within the storm door frame width;
a sash displaceable within the at least one axially oriented track within the inner region of the storm door frame; and
a spring biased screen roller having a screen material wrappably coupleable to the roller at a first end and securable to the sash at a second end to deploy from the roller proximate the storm door frame first surface, and wherein further displacement of the sash within the at least one track in a direction away from the roller urges the screen material along the track abutment plane generally parallel to and within the storm door width generally inward from the storm door frame first surface to abuttably align side portions of the screen material against the at least one face surface of the at least one track.

31. The storm door of claim 30, wherein the at least one track further includes at least one length of weather stripping.

32. The storm door of claim 30, further including a counterbalance system operably coupled to the sash to provide a counteracting force with that of the tension of the spring biased roller.

33. The storm door of claim 30, wherein the sash includes at least one latch mechanism to selectively limit displacement of the sash.

34. The storm door of claim 30, wherein the spring biased roller is housed within a module proximate the header such that the spring biased roller is selectively removable from the module.
